(19) United States
(12) Patent Application Publication
(10) Pub. No.: US 2023/0012693 A1
(43) Pub. Date: Jan. 19, 2023

(54) OPTIMIZED HYPERVISOR PAGING

(71) Applicant: VMWARE, INC., Palo Alto, CA (US)

(72) Inventors: MARCOS K. AGUILERA, Palo Alto, CA (US); DHANTU BURAGOHAIN, Dhemaji (IN); KEERTHI KUMAR, Bangalore (IN); PRAMOD KUMAR, Bangalore (IN); PRATAP SUBRAHMANYAM, Palo Alto, CA (US); SAIRAM VEERASWAMY, Coimbatore (IN); RAJESH VENKATASUBRAMANIAN, Palo Alto, CA (US)

(21) Appl. No.: 17/492,771

(22) Filed: Oct. 4, 2021

(30) Foreign Application Priority Data
Jul. 17, 2021 (IN) 202141032269

(51) Int. Cl. G06F 9/455; G06F 9/50; G06F 11/07

(52) U.S. Cl. CPC G06F 9/45558; G06F 9/5077; G06F 9/5016; G06F 9/5022; G06F 11/0772; G06F 2009/45583

(57) ABSTRACT

Disclosed are various embodiments for optimizing hypervisor paging. A hypervisor can save a machine page to a swap device, the machine page comprising data for a physical page of a virtual machine allocated to a virtual page for a process executing within the virtual machine. The hypervisor can then catch a page fault for a subsequent access of the machine page by the virtual machine. Next, the hypervisor can determine that the physical page is currently unallocated by the virtual machine in response to the page fault. Subsequently, the hypervisor can send a command to the swap device to discard the machine page saved to the swap device in response to a determination that the physical page is currently unallocated by the virtual machine.

### RELATED APPLICATION

Benefit is claimed under 35 U.S.C. 119(a)-(d) to Foreign Application Serial No. 202141032269 filed in India entitled “OPTIMIZED HYPERVISOR PAGING”, on Jul. 17, 2021, by VMware, Inc., which is herein incorporated in its entirety by reference for all purposes.

### BACKGROUND

A guest operating system of a virtual machine can provide memory management services for processes executed by the virtual machine. The guest operating system can allocate pages to processes as needed and deallocate pages when they are no longer needed by a process, such as when a process terminates. Moreover, the hypervisor can manage the pages allocated to a virtual machine for use. Nested or extended page tables can be used to track the multiple levels of page mapping performed by the virtual machine for individual processes within the virtual machine and by the hypervisor for use by individual virtual machines.

However, the hypervisor often lacks any semantic information about a page that it is moving to a swap device or loading from a swap device. For example, a page allocated to a virtual machine by a hypervisor may be eligible for moving to swap because it has not been accessed for a predefined period of time. However, the hypervisor lacks semantic information regarding why the page allocated to the virtual machine has not been accessed for a predefined period of time. For instance, it is possible that the process is simply not currently using the data stored in the page to be swapped, but the process could use the data in the future. However, it is also possible that the process could have terminated and the page is no longer part of the working set of any active processes of the virtual machine. In these instances, the computing overhead associated with the hypervisor swapping the page needlessly consumes computing resources.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a computing device according to various embodiments of the present disclosure.

FIG. 2A is a schematic block diagram illustrating the communicative relationships between the various components of the computing device of FIG. 1.

FIG. 2B is a schematic block diagram illustrating an alternative example of the communicative relationships between the various components of the computing device of FIG. 1.

FIG. 3 is a pictorial diagram of illustrating the how pages can be stored and loaded from a swap device according to various embodiments of the present disclosure.

FIG. 4 is a sequence diagram depicting the interactions between the various components of the computing device of FIG. 1.

FIG. 5 is a sequence diagram depicting the interactions between the various components of the computing device of FIG. 1.

### DETAILED DESCRIPTION

Disclosed are various approaches for eliminating redundant paging in order to optimize the performance of hypervisors. Contextual information about pages allocated by a virtual machine to a process is communicated at regular or periodic intervals to the hypervisor. The hypervisor can then use this additional information to determine whether to load a previously stored page from a swap device back into memory in order to minimize the consumption of computing resources associated with moving pages from a swap device back to memory. By eliminating unnecessary paging from the swap device to memory, the performance of the computing device is improved because time is not wasted by the hypervisor or virtual machines waiting on unnecessary paging from the swap device to memory, improving the overall latency of memory operations.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

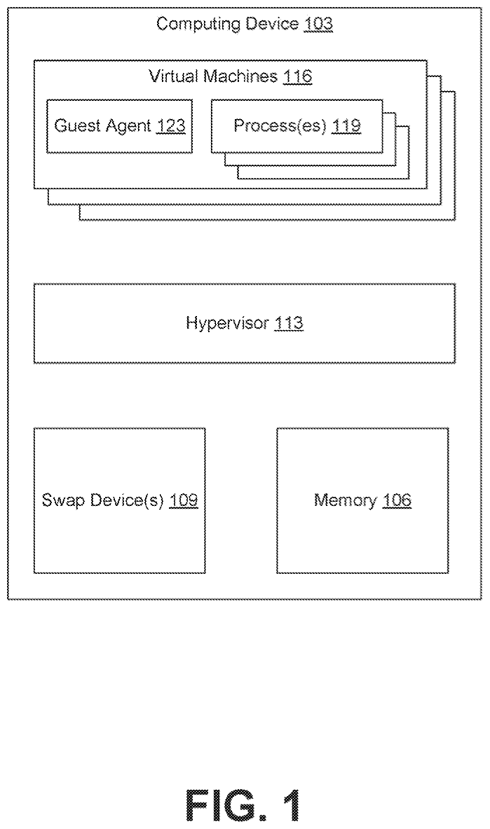

FIG. 1 depicts a schematic block diagram of one example of a computing device 103 according to various embodiments of the present disclosure. The computing device 103 can include one or more processors. The computing device 103 can also have a memory 106. The computing device 103 can also have one or more swap devices 109 attached to a bus or interconnect, allowing the swap devices 109 to be in data connection with the processor and/or memory 106. Examples of swap devices 109 can include solid state disks (SSDs), hard disk drives (HDDs), network attached memory servers or storage servers, etc. The computing device can also execute a hypervisor 113, which includes machine-readable instructions stored in the memory 106 that, when executed by the processor of the computing device 103, cause the computing device 103 to host one or more virtual machines 116.

The hypervisor 113, which may sometimes be referred to as a virtual machine monitor (VMM), is an application or software stack that allows for creating and running virtual machines 116. Accordingly, a hypervisor 113 can be configured to provide guest operating systems with a virtual operating platform, including virtualized hardware devices or resources, and manage the execution of guest operating systems within a virtual machine execution space provided by the hypervisor 113. In some instances, a hypervisor 113 may be configured to run directly on the hardware of the host computing device 103b in order to control and manage the hardware resources of the host computing device 103 provided to the virtual machines 116 resident on the host computing device 103. In other instances, the hypervisor 113 can be implemented as an application executed by an operating system executed by the host computing device 103, in which case the virtual machines 116 may run as a thread, task, or process of the hypervisor 113 or operating system. Examples of different types of hypervisors 113 include ORACLE VM SERVER™, MICROSOFT HYPER-V®, VMWARE ESX™ and VMWARE ESXi™, VMWARE WORKSTATION™, VMWARE PLAYER™, and ORACLE VIRTUALBOX®.

The hypervisor 113 can cause one or more processes, threads, or subroutines to execute in order to provide an appropriate level of functionality to individual virtual machines 116. For example, some instances of a hypervisor 113 could spawn individual host processes to manage the execution of respective virtual machines 116. In other instances, however, the hypervisor 113 could manage the execution of all virtual machines 116 hosted by the hypervisor 113 using a single process.

The virtual machines 116 can represent software emulations of computer systems. Accordingly, a virtual machine 116 can provide the functionality of a physical computer sufficient to allow for installation and execution of an entire operating system and any applications that are supported or executable by the operating system. As a result, a virtual machine 116 can be used as a substitute for a physical machine to execute one or more processes 119.

A process 119 can represent a collection of machine-readable instructions stored in the memory 106 that, when executed by processor of the computing device 103, cause the computing device 103 to perform one or more tasks. A process 119 can represent a program, a sub-routine or sub-component of a program, a library used by one or more programs, etc. When hosted by a virtual machine 116, the process 119 can be stored in the portion of memory 106 allocated by the hypervisor 113 to the virtual machine 116 and be executed by a virtual processor provided by the virtual machine 116, which acts as a logical processor that allows for the hypervisor to share the processor of the computing device 103 with multiple virtual machines 116.

The hypervisor 113 and the virtual machines 116 can each provide virtual memory management functions. The hypervisor 113 can provide virtual memory management functions to the virtual machines 116 hosted on the computing device 103. Accordingly, the hypervisor 113 can determine which pages of the memory 106 are allocated to individual virtual machines 116 and swap pages between the memory 106 and the swap device(s) 109 as needed using various approaches such as the least frequently used (LFU) algorithm or least recently used (LRU) algorithm. Similarly, a virtual machine 116 can provide virtual memory management functions to individual processes 119 hosted by the virtual machine 116. For clarity, the pages of the memory 106 that are managed by the hypervisor 113 and allocated to the individual virtual machines 116 are referred to as machine pages of the computing device 103. Likewise, the set of pages the virtual machine 116 manages within its own address space and allocates to individual processes are referred to as physical pages of the virtual machine 116. Those physical pages of the virtual machine 116 allocated to the address space of an individual process 119 are referred to herein as virtual pages. The mapping of the physical pages of the virtual machines 116 to machine pages of the memory 106 of the computing device 103 can be tracked in the page table of the computing device 103. In these instances, the page table may be referred to as a nested page table or extended page table, depending on the architecture of the processor of the computing device 103. The additional level of mapping of virtual pages of individual processes 119 to physical pages of a virtual machine 116 may also be stored in the page table.

A virtual machine 116 may also be configured to execute a guest agent 123. The guest agent 123 can be executed independently of the processes 119 to monitor the allocation of physical pages of the virtual machine 116 for virtual pages of individual processes 119. The guest agent 123 can be further configured to provide information regarding the current allocation status of individual physical pages to the hypervisor 113. The guest agent 123 can be configured to communicate the allocation status of each physical page when the allocation status changes, or the guest agent 123 can be configured to communicate the allocation status of groups of physical pages in batches to the hypervisor 113.

Generally, the guest agent 123 may be designed in order to avoid changing the source code of the operating system of the virtual machine 116. Using LINUX as an example, the guest agent 123 could monitor two functions of the LINUX kernel using kprobes. The first function handles the exit of individual processes 119. The second function handles the allocation of physical pages to individual processes 119. When a process 119 exits, the guest agent 123 can communicate to the hypervisor 113 the identify of all of the physical pages previously allocated to the process 119 and that the previously allocated physical pages are now unallocated. Similarly, when a physical page of the virtual machine 116 is allocated to a process 119, the guest agent can communicate to the hypervisor 113 the identity of the physical page allocated and that the physical page is now allocated.

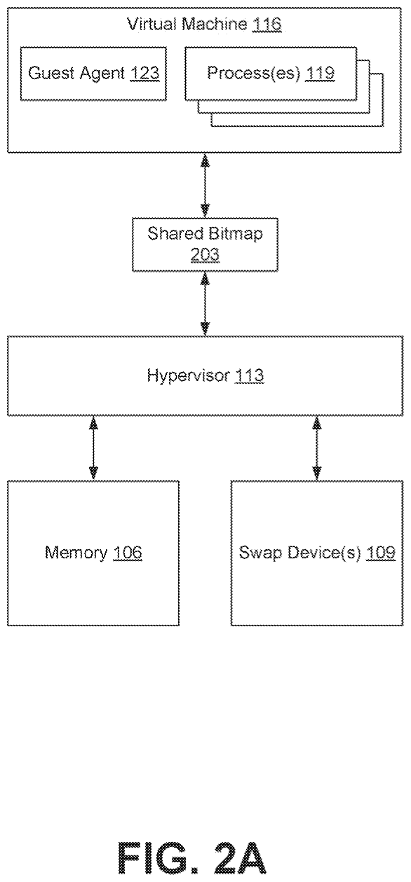

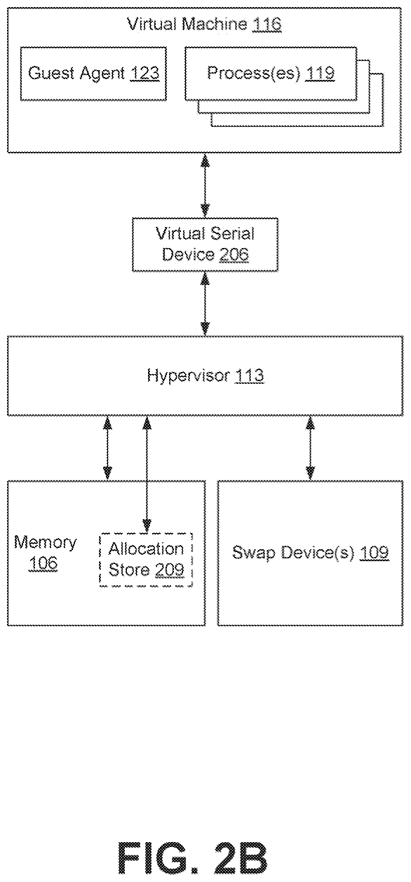

Referring next to FIG. 2A, shown is schematic block diagram illustrating the communicative connections between the components of the computing device 103, such as the hypervisor 113, the virtual machine 116, the memory 106, and the swap devices 109. As illustrated, the hypervisor 113 is in communication with the memory 106 and the swap devices 109. Accordingly, the hypervisor 113 can decide which machine pages to move between the memory 106 and the swap devices 109 based at least in part on which machine pages were the least recently used or the least frequently used pages in the memory 106 or based at least in part on which machine pages are likely to be accessed. The virtual machine 116 and the hypervisor 113 can communicate with each other using a shared bitmap 203. The shared bitmap 203 can be a bitmap with a number of bits equal to the number of physical pages managed by the virtual machine 116. The individual bits of the shared bitmap 203 can represent whether a respective physical page managed by the virtual machine 116 is allocated to a process 119 (e.g., as a virtual page for the process 119).

The guest agent 123 can track which physical pages the virtual machine 116 has allocated to individual processes 119. The guest agent 123 can then write to the shared bitmap 203 to update the values of individual bits in the shared bitmap 203 to reflect the current allocation status of the physical pages of the virtual machine 116. For example, the guest agent 123 could use bitwise operations on the shared bitmap 203 to change the value of individual bits.

The shared bitmap 203 can also be stored in an area of the memory 106 protected against swapping. For example, the shared bitmap 203 could be stored in a page that is pinned to a machine page so it is unable to be swapped out to the swap device 109. Doing so avoids undesirable overheads when accessing the shared bitmap. As another example, the shared bitmap 203 could be stored in a memory page or memory address that is set as read-only or write-protected.

Turning now to FIG. 2B, shown is a schematic block diagram illustrating an alternative example arrangement of the communication connections between the components of the computing device 103, such as the hypervisor 113, the virtual machine 116, the memory 106, and the swap devices 109. As illustrated, the hypervisor 113 is in communication with the memory 106 and the swap devices 109. Accordingly, the hypervisor 113 can decide which machine pages to move between the memory 106 and the swap devices 109 based at least in part on which machine pages were the least recently used or the least frequently used pages in the memory 106 or based at least in part on which machine pages are likely to be accessed. The virtual machine 116 and the hypervisor 113 can communicate with each other using a virtual serial device 206 or similar out-of-band virtual communications device.

The virtual serial device 206 can represent a virtualized serial port connection between the virtual machine 116 and the hypervisor 113 that can be used by the virtual machine 116 to communicate with the hypervisor 113. For example, the guest agent 123 could track which physical pages the virtual machine 116 has allocated to individual processes 119. The guest agent 123 could then send or communicate to the hypervisor 113 the identities of these physical pages and their change in allocation status (e.g., a previously allocated page has been deallocated or a previously unallocated page has been allocated) using the virtual serial device 206. The hypervisor 113, upon receiving this information, could store it in an allocation store 209 for future reference. The allocation store 209 could be implemented as a bitmap that tracks the allocation status of individual physical pages of the virtual machine 116 or as a collection of data structures that represent the physical pages of the virtual machine 116 and their current allocation status.

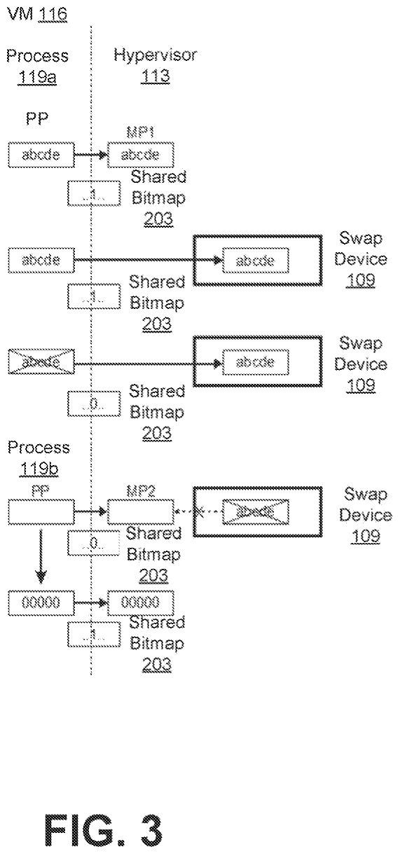

Moving on to FIG. 3, shown is graphical illustration of the process for optimized paging using the shared bitmap 203. As shown, a virtual machine 116 can have a process 119a executing. A physical page “PP” with the contents “abcde” is mapped to a machine page “MP1” managed by the hypervisor 113. A respective bit in the shared bitmap 203 indicates that physical page PP is currently allocated to the process 119a as a virtual page.

Subsequently, the hypervisor 113 moves the machine page “MP1” to the swap device 109. This could be done by the hypervisor 113 in order free or reclaim pages in memory 106 for other purposes. For example, the virtual machine 116 may not have attempted to access the machine page “MP1” within a preceding interval of time, so the machine page “MP1” was moved by the hypervisor 113 to the swap device 109 to free space for pages that are more actively used. Notably, the physical page “PP” is still indicated within the shared bitmap 203 as being allocated to the process 119a by the virtual machine 116.

Later, the physical page “PP” may be deallocated by the virtual machine 116. For example, the process 119a may have exited or otherwise ceased operation, so that the physical page “PP” was deallocated or otherwise reclaimed by the virtual machine 116. Accordingly, the shared bitmap 203 can be updated by the virtual machine 116 to reflect that the physical page “PP” is no longer allocated by the virtual machine 116 to the process 119a. However, while the physical page “PP” can also be marked as not present, its contents are still located within the swap device 109.

Subsequently, process 119b can begin execution on the virtual machine 116. Accordingly, the virtual machine 116 could reallocate physical page “PP” to the new process 119b. This could cause the process 119b to access the physical page “PP,” which would cause the virtual machine 116 to access a page which is not present, which would trigger a page fault.

Traditionally, when a page fault is triggered, the hypervisor 113 would map a new machine page “MP2” in the memory to the physical page “PP” and load the contents of previously swapped out “MP1” (depicted as data “abcde”) into the newly mapped machine page “MP2.” However, because the data “abcde” is from the terminated process 119a, it is not needed for process 119b. Therefore, loading this data from the swap device 109 into memory 106 would both unnecessarily consume computing resources, but would also post a potential security risk by disclosing data from one process 119a to another process 119b.

Accordingly, when processing the page fault, the hypervisor 113 can evaluate the shared bitmap 203 to determine whether the contents of the physical page “PP” that were saved to the swap device 109 are for an allocated physical page or an unallocated physical page. As illustrated, the hypervisor 113 could evaluate the shared bitmap 203 to determine that the contents of the physical page “PP” stored in the swap device are for an unallocated physical page. In response, the hypervisor 113 could discard the contents from the swap device 109 instead of loading them into memory 106. The reallocated physical page “PP” could then be mapped to machine page “MP2”. The virtual machine 116 or the process 119b could then write data to the reallocated physical page “PP” (e.g., by writing all zeroes to the physical page “PP” to clear the contents). Then, the shared bitmap 203 could be updated to indicate that the physical page “PP” is mapped to a machine page, such as machine page “MP2.”

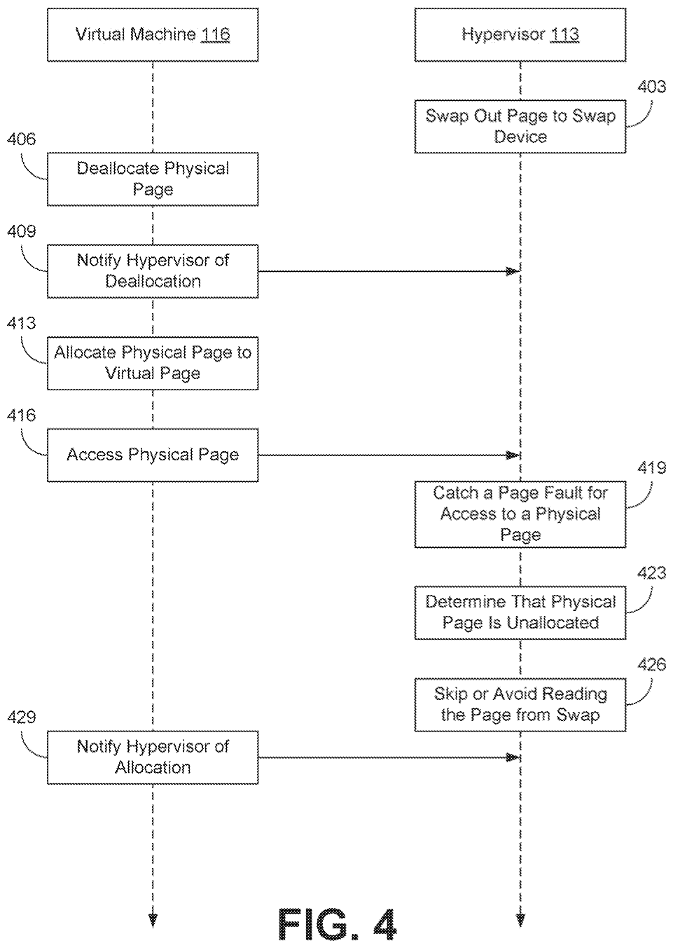

Referring next to FIG. 4, shown is a sequence diagram that provides one example of the interactions between a virtual machine 116 and the hypervisor 113. The sequence diagram of FIG. 4 provides merely an example of the many different types of interactions between a virtual machine 116 and the hypervisor 113. As an alternative, the flowchart of FIG. 4 can be viewed as depicting an example of elements of a method implemented within the computing device 103.

Beginning with block 403, the hypervisor 113 can swap out the physical page from the memory 106 of the computing device 103 to the swap device 109.

Then, at block 406, the virtual machine 116 can deallocate a physical page of the virtual machine. This could occur, for example, when a process 119 executed by the virtual machine 116 terminates or exits and the physical pages previously allocated to the process 119 as virtual pages are no longer needed for the process 119. Accordingly, the virtual machine 116 could deallocate the physical pages so that they could be reallocated for use by another process 119 at a later time.

Meanwhile, at block 409, the virtual machine 116 can notify or otherwise communicate to the hypervisor 113 that the physical page was deallocated at block 406. This can be done using a variety of approaches. For example, the guest agent 123 could detect that the process 119 had terminated (e.g., using kprobes if the virtual machine is a running a LINUX kernel), and then report the identities of all of the physical pages of the virtual machine 116 allocated to the process 119 as having been deallocated. For example, the guest agent 123 could write to a shared bitmap 203 using bitwise operations to update the bits for the respective physical pages (e.g., by setting each respective bit to a value of zero). As another example, the guest agent 123 could send a message using an out-of-band communication channel, such as a virtual serial device 206. The message could identify the physical pages that have been deallocated and also include their updated allocation status (e.g., that the page is now “deallocated” or “unallocated” instead of “allocated”).

Subsequently, at block 413, the virtual machine 116 can allocate a physical page for use by a process. For example, a new process 119 could begin execution and the virtual machine 116 could allocate one or more physical pages to the process 119 for use as virtual pages by the process 119. The physical pages to be allocated could be selected by the virtual machine 116 from the set of currently unallocated physical pages, which can include the physical page(s) that were deallocated previously at block 406. For illustrative purposes, the remaining discussion of FIG. 4 assumes that a physical page deallocated at block 406 is allocated by the virtual machine 116 at block 413. However, the various embodiments of the present disclosure would work the same regardless of whether the physical page allocated at block 413 had been previously deallocated at block 406 or is another unallocated physical page.

Next, at block 416, the virtual machine 116 can access the physical page reallocated at block 413. The access may be done by the virtual machine 116 to clear the contents of the physical page as a security measure prior to the process 119 for which the physical page is allocate is permitted to use the physical page. This can prevent a malicious process 119 from reading the data of a previously executing process 119 that remains in the physical page. For example, the virtual machine 116 may access the physical page to write sequential values of zero or one to the page, which can be referred to as zeroing-out the physical page. Because the physical page was previously swapped out to the swap device 109 at block 403, the access will cause a page fault to occur.

Then, at block 419, the hypervisor 113 can catch the page fault in response to the attempt by the virtual machine to access the physical page that was swapped out. In response, the hypervisor 113 can, at block 423 determine whether the physical page is currently allocated. For example, the hypervisor 113 could evaluate a shared bitmap 203 to see if the respective bit is set to a value of zero, indicating that the physical page is unallocated, or is set to a value of one, indicating that the physical page is allocated. As another example, the hypervisor 113 could evaluate an allocation store 209 to determine whether the hypervisor 113 has previously received an indication from the virtual machine 116 regarding whether the physical page is currently allocated to a process by the virtual machine 116.

Assuming that the hypervisor 113 has determined that the shared bitmap 203 or the allocation store 209 indicates that the physical page is unallocated, then the hypervisor 113 can, at block 426, skip or avoid reading the contents of the physical page from the swap device. This can be done in order to avoid consuming memory bandwidth and processor resources loading the contents of the physical page from the swap device 109 when the contents of the physical page on the swap device are no longer used by a process 119 executing in the virtual machine 116.

Meanwhile, at block 429, the virtual machine 116 can notify the hypervisor 113 that the physical page that was mapped to the discarded machine page has been allocated. For example, the guest agent 123 could use a bitwise operation to update the shared bitmap 203 to reflect the allocation of the physical page by the virtual machine 116 at block 413. As another example, the guest agent 123 could send a communication or notification to the hypervisor 113 using an out-of-band communication channel, such as the virtual serial device 206, to inform the hypervisor 113.

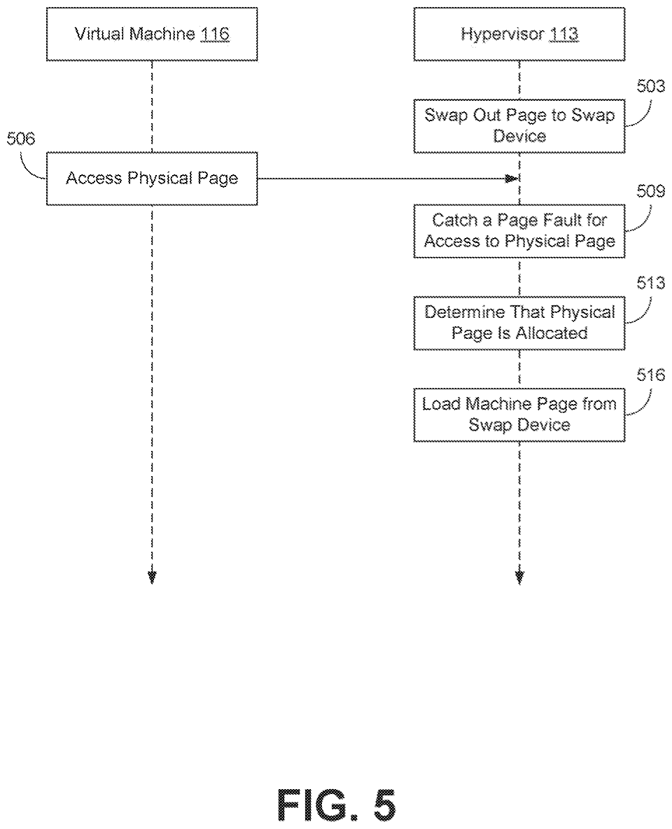

Referring next to FIG. 5, shown is a sequence diagram that provides one example of the interactions between a virtual machine 116 and the hypervisor 113. The sequence diagram of FIG. 5 provides merely an example of the many different types of interactions between a virtual machine 116 and the hypervisor 113. As an alternative, the flowchart of FIG. 5 can be viewed as depicting an example of elements of a method implemented within the computing device 103.

Beginning with block 503, the hypervisor 113 can swap out a machine page mapped to a currently allocated physical page from the memory 106 of the computing device 103 to the swap device 109. Although the physical page remains allocated, it may no longer be part of the active set of machine pages used by the virtual machine 116. This could occur, for example, if a process 119 that allocated the physical page has paused execution or suspended execution, or otherwise stopped using the physical page for any reason. Accordingly, the machine page mapped to the physical page can become a candidate for eviction to the swap device 109 as it becomes a least recently used page or a least frequently used page.

Then, at block 506, the virtual machine 116 can access the physical page that was saved to the swap device 109 at block 503. This could occur, for example, when the process 119 that the physical page is allocated to as virtual page resumes execution or otherwise attempts to access data in the allocated physical page. Because the physical page was swapped out to the swap device 109 at block 503, a page fault occurs. Accordingly, at block 509, the hypervisor 113 can catch the page fault for the physical page and handle it.

Moving on to block 513, the hypervisor 113 can determine whether the physical page being accessed by the virtual machine 116 is allocated to a process 119 by the virtual machine 116. For example, the hypervisor 113 could evaluate a shared bitmap 203 to see if the respective bit is set to a value of one, indicating that the physical page is allocated, or is set to a value of zero, indicating that the physical page is unallocated. As another example, the hypervisor 113 could evaluate an allocation store 209 to determine whether the hypervisor 113 has previously received an indication from the virtual machine 116 regarding whether the physical page is currently allocated to a process by the virtual machine 116.

Assuming that the hypervisor 113 has determined that the shared bitmap 203 or the allocation store 209 indicates that the physical page is currently allocated to a process 119 by the virtual machine 116, then the hypervisor 113 can load the machine page from the swap device 109 to the memory 106 of the computing device 103 at block 516. The virtual machine 116 can then access the physical page as desired.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

What is claimed is:

1. A system, comprising:
a computing device comprising a processor, a memory, and a swap device; and
a hypervisor comprising machine-readable instructions stored in the memory that, when executed by the processor, cause the computing device to at least:
swap out a page to the swap device, the page corresponding to a physical page of a virtual machine allocated to a virtual page for a process executing within the virtual machine;
catch a page fault for a subsequent access of the physical page by the virtual machine;
determine that the physical page is currently unallocated by the virtual machine in response to the page fault; and
skip reading the page from the swap device in response to a determination that the physical page is currently unallocated by the virtual machine.

2. The system of claim 1, wherein the physical page is mapped to a first machine page and the machine-readable instructions, when executed by the processor, further cause the computing device to at least map the physical page to a second machine page in response to the page fault.

3. The system of claim 1, wherein the machine-readable instructions of the hypervisor that cause the computing device to determine that the physical page is currently unallocated further cause the computing device to at least:
evaluate a shared bitmap, the shared bitmap comprising a bit that indicates whether the physical page is currently unallocated by the virtual machine.

4. The system of claim 3, wherein the shared bitmap is read-only for the hypervisor and readable and write-able by the virtual machine.

5. The system of claim 3, wherein the shared bitmap is stored in a pinned page.

6. The system of claim 1, wherein the machine-readable instructions of the hypervisor further cause the computing device to at least:
receive a message from the virtual machine though a virtual serial device, the message identifying the physical page as being unallocated;
update an allocation bitmap, the allocation bitmap comprising a bit that indicates whether the physical page is currently unallocated by the virtual machine; and
evaluate the allocation bitmap to determine that the physical page is currently unallocated.

7. The system of claim 1, wherein the machine-readable instructions of the hypervisor further cause the computing device to at least receive an indication that the physical page has been allocated by the virtual machine subsequent to the page fault.

1. A method implemented by a virtual machine, comprising:
allocating a physical page of the virtual machine to a virtual page;
accessing the physical page; and
notifying a hypervisor managing the virtual machine that the physical page has been allocated in response to accessing the physical page.

9. The method implemented by the virtual machine of claim 8, wherein accessing the physical page further comprises zeroing-out the physical page.

10. The method implemented by the virtual machine of claim 8, wherein notifying the hypervisor managing the virtual machine that the physical page has been allocated further comprises updating a shared bitmap to indicate that the physical page has been allocated to the virtual page.

11. The method implemented by the virtual machine of claim 8, wherein notifying the hypervisor managing the virtual machine that the physical page has been allocated further comprises sending a message through a virtual serial device to the hypervisor, the message identifying the physical page as being allocated.

12. The method implemented by the virtual machine of claim 8, further comprising:
deallocating the physical page allocated to the virtual page; and
notifying the hypervisor managing the virtual machine that the physical page has been deallocated.

13. The method implemented by the virtual machine of claim 8, wherein the virtual page is a first virtual page associated with a first process, and the method further comprises:
allocating the physical page of the virtual machine to a second virtual page associated with a second process;
accessing the physical page; and
notifying the hypervisor managing the virtual machine that the physical page has been allocated in response to accessing the physical page.

14. A non-transitory, computer-readable medium, comprising machine-readable instructions for a hypervisor that, when executed by a processor of a computing device, cause the computing device to at least:
swap out a page to the swap device, the page corresponding to a physical page of a virtual machine allocated to a virtual page for a process executing within the virtual machine;
catch a page fault for a subsequent access of the physical page by the virtual machine;
determine that the physical page is currently unallocated by the virtual machine in response to the page fault; and
skip reading the page from the swap device in response to a determination that the physical page is currently unallocated by the virtual machine.

15. The non-transitory, computer-readable medium of claim 14, wherein the physical page is mapped to a first machine page and the machine-readable instructions, when executed by the processor, further cause the computing device to at least map the physical page to a second machine page in response to the page fault.

16. The non-transitory, computer-readable medium of claim 14, wherein the machine-readable instructions of the hypervisor that cause the computing device to determine that the physical page is currently unallocated further cause the computing device to at least:
evaluate a shared bitmap, the shared bitmap comprising a bit that indicates whether the physical page is currently unallocated by the virtual machine.

17. The non-transitory, computer-readable medium of claim 14, wherein the shared bitmap is read-only for the hypervisor and readable and write-able by the virtual machine.

18. The non-transitory, computer-readable medium of claim 14, wherein the shared bitmap is stored in a pinned page.

19. The non-transitory, computer-readable medium of claim 14, wherein the machine-readable instructions of the hypervisor further cause the computing device to at least receive an indication that the physical page has been allocated by the virtual machine subsequent to the page fault.

20. The non-transitory, computer-readable medium of claim 14, wherein the machine-readable instructions of the hypervisor further cause the computing device to at least:
receive a message from the virtual machine though a virtual serial device, the message identifying the physical page as being unallocated;
update an allocation bitmap, the allocation bitmap comprising a bit that indicates whether the physical page is currently unallocated by the virtual machine; and
evaluate the allocation bitmap to determine that the physical page is currently unallocated.
